(19) United States
(12) Patent Application Publication
(10) Pub. No.: US 2014/0344037 A1
(43) Pub. Date: Nov. 20, 2014

(54) DIGITAL EXCHANGE SERVING AS AN INTEGRATED, CONTINUOUS SPONSORSHIP AND PROMOTION SYSTEM FOR COMMUNITY BUSINESSES, ORGANIZATIONS, AND SCHOOLS

(71) Applicants: William R. Dunbar, Oconomowoc, WI (US); Matthew Dennis Serpe, Kenosha, WI (US)

(72) Inventors: William R. Dunbar, Oconomowoc, WI (US); Matthew Dennis Serpe, Kenosha, WI (US)

(73) Assignee: VigeoMedia, LLC, Kenosha, WI (US)

(21) Appl. No.: 14/278,259

(22) Filed: May 15, 2014

Related U.S. Application Data
(60) Provisional application No. 61/823,753, filed on May 15, 2013.

(51) Int. Cl. G06Q 30/02; G06Q 30/06

(52) U.S. Cl. CPC G06Q 30/0279; G06Q 30/0633; G06Q 30/0255; G06Q 30/0247; G06Q 30/0214; G06Q 30/0226
USPC 705/14.16; 705/329; 705/26.8; 705/14.53; 705/14.46; 705/14.27

(57) ABSTRACT

A method of operating a digital system where the method includes providing a server connected to a communications network configured for two-way communications for system users, and configuring the server to display purchase offers, prizes, or other marketing information on user devices. The method also includes linking scannable codes with the digital system and user devices, so that when one of the scannable codes is scanned, the user device, on which the scan was made, is connected to a website where an offer is presented, wherein the offer can be a discount associated with a purchase, a sponsorship amount associated with a purchase, a gift card, a rebate, or a prize.

### CROSS-REFERENCE TO RELATED PATENT APPLICATIONS

This patent application claims the benefit of U.S. Provisional Patent Application No. 61/823,753, filed May 15, 2013, the entire teachings and disclosure of which are incorporated herein by reference thereto.

### FIELD OF THE INVENTION

This invention generally relates to systems and methods for tracking, advising and promoting business and organization activities within a community in a continuous integrated sponsorship marketplace and media network.

### BACKGROUND OF THE INVENTION

In many cases, community organizations, such as youth sports leagues, church groups, and social organizations, rely on sponsorships by local businesses, for example, to fund ongoing operations. Thus, fundraising becomes an important function of the community organization. At the same time these businesses rely on the purchasing power of the organization's members and associates. Thus the digital exchange provides a system and method for sponsorship communications, proposals, acceptance between the businesses, community organizations and complying members and associates with measurable rewards.

To the extent possible, it may be advantageous for community organizations to utilize various media outlets to aid in their fundraising activities. However, for many community organizations, the access cost may be a barrier to certain types of media. Typically, news and information flow to a media outlet via paper transfers, voicemails and telephone conversations, electronically through email systems, electronically through established media interfaces, and/or via field reporters. In most cases, the news and information (data, etc.) input is accomplished manually in the sense that an action must be taken beyond the normal operation of the news event in order to input news to the local media company.

Embodiments of the invention provide a system and method to facilitate sponsorship of community organizations that can be integrated with communications information and news flow networks. These and other advantages of the invention, as well as additional inventive features, will be apparent from the description of the invention provided herein.

### BRIEF SUMMARY OF THE INVENTION

Embodiments of the present invention advantageously address the issues of how organizations can utilize a portion of their continuous sponsorship within a community to cost-effectively create visibility for their organization and how businesses, or sponsors, can automatically be positioned to receive recognition across an integrated media network in a continuous sponsorship environment.

In one aspect, embodiments of the invention provide a method of operating a digital exchange system. The method includes providing a server connected to a communications network configured for two-way communications with system users, and configuring the server to display, on a system-user device, information on one or more community organizations or individuals and sponsorship needs thereof. The method further includes accepting, and displaying on the system-user device, electronically-submitted sponsorship offer plans from a sponsor for one of the one or more community organizations or individuals. The method also calls for accepting data regarding the one or more community organizations or individuals and the sponsor. The data is submitted electronically by system users associated with the sponsor or the one or more community organizations or individuals. The method includes registering a participant desiring to participate in one or more sponsorship offer plans. This participation establishes an electronic link in the digital exchange system between the participant and the one or more community organizations or individuals. The method further includes tracking an extent of participation in the sponsorship offer plan by the participant, allocating proceeds to the one or more community organizations or individuals based on the extent of participation in the sponsorship offer plan by the participant, and electronically receiving pledge amounts of purchase or pledge amounts of sponsorship from the participant.

In a particular embodiment, the method requires facilitating purchase selections by the participant from a list of consumer item, the selections made via a user interfaces, and calculating sponsorship amounts based on the participant selections. The method may also include providing possible purchase opportunities and locations of businesses to make purchases so that the participant can attain the pledged amount of sponsorship. In one embodiment, the method calls for notifying the participants about opportunities to purchase with specific sponsorship offers from sponsors.

In certain embodiments, the method requires integrating the digital exchange system with a digital media network that contains digital media publications configured to provide electronic magazines, websites, and mobile applications. Participants are provided subscriptions to such digital media publications, or pre-subscriptions to potential digital media publications, where the subscriptions are linked to the digital exchange system. The method also includes requesting registration of individuals for participation in one or more sponsorship offer plans or for subscription to the digital media network.

In alternate embodiments, the method calls for integrating the digital exchange system with a digital media network that contains digital media publications configured to provide electronic magazines, websites, and mobile applications. Participants are provided subscriptions to such digital media publications, or pre-subscriptions to potential digital media publications, where the subscriptions are linked to the digital exchange system. The method also includes electronically sending information regarding sponsorship and media platform subscriptions, and summarizing results of the participants and comparing the results to those of an organization or subgroup and the goals of the organization and subgroup.

In another alternate embodiment, the method includes integrating the digital exchange system with a digital media network that contains digital media publications configured to provide electronic magazines, websites, and mobile applications. Participants are provided subscriptions to such digital media publications, or pre-subscriptions to potential digital media publications, where the subscriptions are linked to the digital exchange system. The method also includes tracking activity in the digital exchange system, allocating media coverage points, earned each time a tracked activity is detected on the digital exchange system, and notifying the one or more organizations or individuals when a specified level of media coverage points are earned, making the one or more organizations or individuals aware that media coverage on the digital media network is available.

The method may also include electronically sending a request to an individual to participate in a specific sponsorship initiative, event or sponsorship offer plan. In some embodiments, the method requires automatically sending an electronic communication with information regarding the acceptance of a sponsorship proposal by one of the one or more individuals or community organizations or a subgroup within that community organization, or by the sponsor, and electronically sending a petition from the participant to other participants and individuals to participate in the accepted sponsorship proposal. The digital system provides an ID for those that accept the request and are not currently linked to the relevant organization, school or subgroup. Further embodiments of the method include electronically receiving a sponsorship proposal from a participant for a sponsorship event or sponsorship offer plan, where the sponsorship proposal is created by the participant from a template stored on the digital exchange system, and electronically sending the proposal from the participant to a potential sponsor.

In certain embodiments, the method includes electronically receiving a response from the potential sponsor accepting or declining the offer, or receiving an alternate sponsorship proposal from the potential sponsor, and automatically sending notifications to participants, linked by the communications network, once the response is received. The method may further include placing a scannable code on a media platform. In this instance, one of the system users scans the scannable code and the respective system-user device is connected to a website to propose a sponsorship event or sponsorship offer plan. The method may also include electronically sending a request from the participant for a pledge arrangement to be used to attain a sponsorship goal or for one or more sponsorship offer plans.

In another aspect, embodiments of the invention provide a method of operating a digital system. The method includes providing a server connected to a communications network configured for two-way communications for system users, and configuring the server to display purchase offers, prizes, or other marketing information on system-user devices. The method also requires linking scannable codes with the digital system and system-user devices. When one of the scannable codes is scanned, the system-user device, on which the scan was made, is connected to a website where an offer is presented. The offer can be a discount associated with a purchase, a sponsorship amount associated with a purchase, a gift card, a rebate, or a prize.

In certain embodiments, the offer is unique to the user. The uniqueness of the offer is determined by an algorithm or set of algorithms within the digital system, and is based on an activity of the user within the digital system or information input by the user into the digital system. In other embodiments of the invention, reward points are earned when the user scans one of the scannable codes. The reward points may affect the offers presented. Furthermore, accepted and unaccepted offers are tracked by the digital system, and an entity providing the offer is charged a first amount for each scan that does not result in a sale, and is charged a second amount, higher than the first amount, for each scan that does result in a sale.

The claimed method may also include automatically tracking code scan costs, or providing the offers to target specific customer sets. In some embodiments, the customer set includes network users that are not currently customers of the entity, where the customer set is defined by the entity providing the offer. The customer set may include network users that agree to make purchases at non-peak hours, or on non-peak days, or during non-peak seasons of the year. Alternatively, the customer set may include network users that belong to specific community organizations, or schools, or groups, or teams.

In a particular embodiment, advertising credits are earned by an entity providing offers and paying for scans of the scannable codes, and wherein the advertising credits can be applied to an advertisement or promotion in a media outlet where the scans originated or in another media outlet. The method may also include the steps of linking the scannable codes to a system that serves as an entry point to a service directory. When the scannable code is scanned by a system user, the system-user device is connected to a website that contains a service directory, and displays offers, for system users, from members listed in the service directory. The offers may include prizes or gift cards. In further embodiments, a referral network is included, wherein system users, linked by the communications network, provide referrals to each other. Gift cards or reward points may be earned by system users providing referrals. In certain embodiments, reward points are earned each time a system user scans a scannable code and is connected to a website to view an offer. In the digital system—the reward points can be redeemed to reduce a subscription price for a media platform.

In yet another aspect, embodiments of the invention provide a method of operating a digital system. The method includes the steps of providing a server connected to a communications network configured for two-way communications for system users, configuring the server to display contest information, and linking scannable codes with the system and user devices. When one of the scannable codes is scanned, the user device that scanned the scannable code is connected to a website where information is presented and questions pertaining to that information displayed. The method further includes accepting and displaying, on a system-user device, user answers to the questions, subsequently displaying correct answers and comparing the correct answers with the user answers, and indicating whether the user has received a prize or been entered into a drawing for a prize.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a block diagram that shows a digital exchange system and its interaction with sponsors, community organizations or individuals, and participants, according to an embodiment of the present invention;

FIG. 2 is a block diagram illustrating various components of the digital exchange system, according to an embodiment of the invention;

FIG. 3 is a block diagram illustrating a digital media network constructed in accordance with an embodiment of the invention;

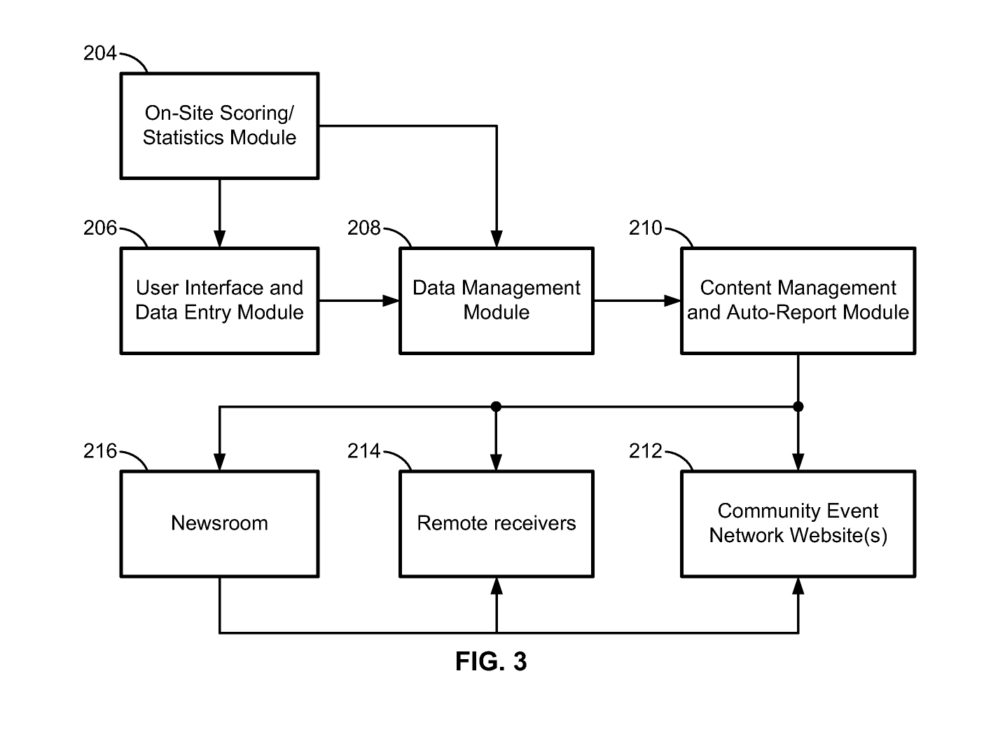

FIG. 4 is a flowchart illustrating an exemplary method of operating a digital exchange system, according to an embodiment of the invention;

FIG. 5 is a flowchart illustrating an exemplary method of operating a digital system using scannable codes, according to an embodiment of the invention; and

FIG. 6 is a flowchart illustrating an exemplary method of operating a digital system, according to an alternate embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

There is a need for an effective system to track the support and sponsorship with the purpose of directing resources to assist the sponsorship needs while assigning recognition within an integrated media network. Thus, as more and more organizations within a community create arrangements with businesses for continuous sponsorship, the need to provide a more automated and quantifiable method for resource allocation and recognition is apparent.

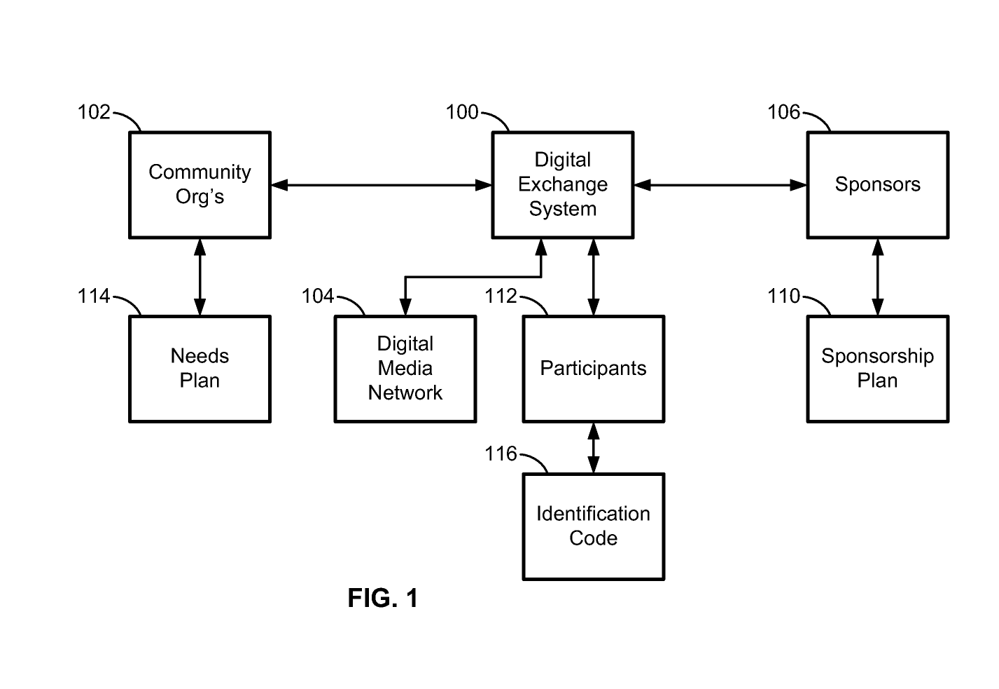

As shown in FIG. 1, embodiments of the present invention provide a digital exchange system 100 to track the support and sponsorship of community organizations 102 for the purpose of directing resources to assist the sponsorship needs while assigning recognition within an integrated digital media network 104. Further, embodiments of the invention permit community organizations 102 to create arrangements with sponsors 106 for continuous sponsorship, and to provide an automated and quantifiable method for resource allocation and recognition.

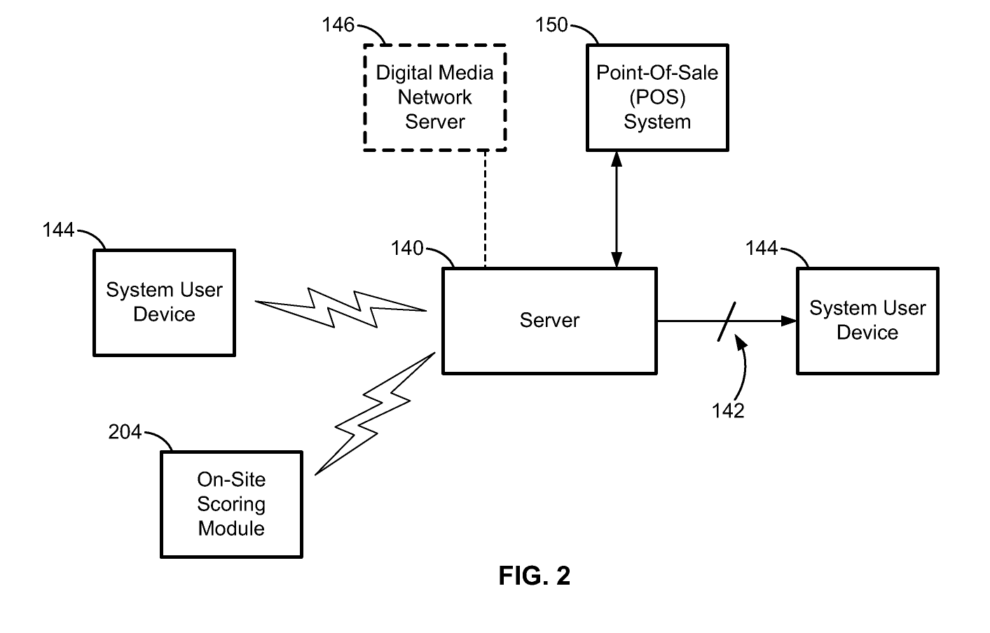

In at least one embodiment, a digital exchange system 100 for facilitating sponsorship of community organizations 102 includes a server 140 (see FIG. 2) connected to a network 142 (see FIG. 2), such as the internet, an intranet, cellular and/or Wi-Fi network, and programmed to provide for the electronic dissemination of community-based information, and programmed to provide a digital exchange system 100 to facilitate the sponsorship of community organizations 102 by sponsors 106 and participants 112.

FIG. 2 is a schematic block diagram that illustrates the server 140, network 142, and system user devices 144, according to an embodiment of the invention. System user devices 144 include, for example, personal computers connected to the internet or an intranet, mobile wireless devices such as smartphones or tablets. These system user devices 144 may be employed by members of the community organization 102, by the sponsor 106 and its employees, agents or affiliates, participants 112 in the sponsorship offer plan, also referred to as sponsorship plan 110, crowd-sourced reporters, etc. The server 140 may also be configured to wirelessly communicate with on-site scoring modules 204, which are discussed in more detail below. The primary elements of the digital media network 104 may reside on server 140, or optionally may reside on a digital media network server 146 (shown in phantom) in communication with server 140.

Embodiments of the present invention include a system and method which provide community organizations 102 and sponsors 106 an integrated, automated system that serves to match the needs of the organizations 102 (and the people therein) with the objectives of the sponsors 106 within a community and/or region.

In particular embodiments of the invention, community organizations 102 connect to the digital exchange network 100 in three primary ways:

1. A connection between the server 140 and system user from the community organization 102 that allows the system user to register and electronically submit a needs plan 114 that describes the needs of the community organization 102—and then based on that needs plan 114, receive automated reports generated by the system that assist the community organization 102 with visibility and sponsorship. Demographic, contact, and descriptive information may be provided by the community organization 102 as a part of a community organization profile. Details regarding desired sponsorship are provided as a part of the needs plan 114.

2. Use of the aforementioned connection that allows the system user to submit content about their activities and accomplishments for publishing on the digital media networks 104.

3. Connection to the digital exchange system 100 to:
Receive proposals from the sponsors 106;
Offer proposals to the sponsors 106; and
Participate in sponsorship plan 110 that results from purchases by the sponsorship plan participants 112.

The diagram of FIG. 1 also shows how sponsors 106 can interface with or connect to the network 142 (shown in FIG. 2) in three ways:

1. A sponsor 106 may join the digital exchange system 100 by electronically submitting registration information via the digital exchange system 100. In a particular embodiment, as an integral part of the sponsor registration, the sponsor 106 develops (and maintains thereafter) the sponsorship plan 110 and a sponsor objectives plan by filling out a template of information about the sponsor 104. For example, a restaurant may have an objective to increase business on a certain day of the week, and construct a sponsorship plan 110 that corresponds to that objective. Demographic, contact, and descriptive information may be provided by the sponsor 106 as a part of a sponsor profile.

2. Connection to the digital exchange system 100 to:
Receive proposals from community organizations 102;
Offer proposals to the community organizations 102;
Receive communications and recommendations from the digital exchange system 100 regarding various proposals;

3. Connection to the digital exchange system 100, which is attached to the digital media networks 104, and wherein the digital exchange system 100 may be configured to automatically place various types of promotions and/or advertisements that roll into one or more digital media networks 104.

In this way, the digital exchange system 100 facilitates sponsorship of community organizations. The digital exchange system server 140 is connected to a network and programmed to provide a system for the dissemination of community-based information, and programmed to provide a digital exchange to facilitate the sponsorship of community organizations by businesses and individuals. Embodiments of the present invention offer community organizations and sponsors an integrated, automated system that serves to match needs of organizations (and the people therein) with objectives of businesses within a community or region.

Community residents that are affiliated with organizations, either directly such as students, players or participants, or indirectly, such as alumni or supporters, also complete a profile template (and maintain thereafter).

An “Advise” section of the network contains an algorithm that monitors the on-going transactions through the system. The “Advise” system tracks, for example, the following and/or performs the following calculations: monthly purchase amounts input through the system—total from all businesses in a given community/region, breakdown by Business Category (categories e.g., as shown in the Digital Sponsor Platform), breakdown by Business Category averages, breakdown by Organization, i.e., purchase amounts attributed to each organization, and breakdown by Organization on a per user ID card (e.g., $100,000 of purchases were recorded in the exchange system for a specific organization and the organization has 500 ID cards, resulting therefore in an average for this organization of $200/ID card); for each participating business, number of registered users in each community organization or school that have made a purchase in the recent past (e.g., by month, over the last 6 months), comparing that to the total number of registered users in each community organization or school.

Participants 112, whether individuals or some other type of entity, may also be asked to register and to provide information which could be used to construct a participant profile. Part of the registration process may involve issuance of a unique identification code 116 for the participant.

In any community, there may be events which could affect sponsorship levels, or which could be used to affect sponsorship levels. To take advantage of these instances, community organizations 102 and sponsors 106 may disseminate information regarding the event and/or the sponsorship via the digital media network 104. In some cases, information may be efficiently disseminated by crowd-sourced reporting in which spectators or members of the general public provide facts, reporting, video, etc. to communicate the desired message. The digital media network 104 may be configured to electronically send out alerts soliciting crowd-sourced reporting, and further configured to process the information provided by such crowd-sourced reporting.

The digital exchange system 100 may also be configured to track one or more customer loyalty programs implemented by a particular sponsor 106, and allocate funds to the community organization 102 and awards to the participants 112 in accordance with the requirements of the customer loyalty program. Under some customer loyalty programs, customers may fall into any one of several program categories (e.g., platinum, gold, silver, etc.) which identify the status of the customer. The sponsor 106 may base certain allocations on a participant's status under the customer loyalty program. The digital exchange system 100 may be further configured to generate reports showing, for example, purchase history of participants 112, affiliations, interests, etc. In some embodiments, the digital exchange system 100 is configured to automatically notify participants 112 and sponsors 106 when the participant 112 is eligible for an award under the customer loyalty program. Additionally, it should be noted that, in a particular embodiment of the digital exchange system 110, sponsors 106 are able to offer sponsorship plans 110 allocating money to a community organization 102 that does not require participants 112 to register or to explicitly indicate any support for the community organization or acceptance of the sponsorship plan 110.

In certain embodiments, the on-site scoring/statistics module 204 receives data from crowd-sourced reporters. The module 204 can interface with or be an integral part of hardware devices such as portable electronic scoring devices, scoreboards, etc. to automatically obtain the data. The data can include information relating to a community event, a sporting event, an advertisement, a promotional event and the like. The module 204 interfaces with a user interface and data entry module 206 that sends the data to data management module 208. The user interface and data entry module 206 may also receive data from crowd-sourced reporters. Alternatively, module 204 directly sends data to data management module 208.

Data entered is stored in data management module 208, from which calculations are performed resulting in another level of analytics, such as sporting statistics, purchasing behavior, such as batting averages, earned run averages, team/individual standings, etc. Data management module 208 may include multiple data storage servers located at one or more selected locations. For example, the servers could be stored in a central location or distributed throughout the communities being served.

The content management and auto-report module 210 transforms the data into a format for viewing at community event network website(s) 212 and/or at remote receivers 214 throughout the community and/or region. The auto-report function automatically transforms parts of the data entered into print-ready verbiage for display on/in the various platforms. Print-ready verbiage means the data is in a grammatically correct format that is readable by an end user or ready for additional editing or review at newsroom 216. Newsroom 216 may be a newspaper newsroom, a television news station, news-based website, etc.

In a particular embodiment, the digital exchange system 100 contains an algorithm that monitors the on-going transactions through the system. The digital exchange system 100 tracks, among other things, the following and/or performs the following calculations: monthly purchase amounts input through the system—total from all sponsors in a given community/region, breakdown by business category (categories e.g., as shown in a digital sponsor network), breakdown by business category averages, breakdown by organization, i.e., purchase amounts attributed to each organization, and breakdown by organization on a per user ID card (e.g., $100,000 of purchases were recorded in the exchange system for a specific organization and the organization has 500 ID cards, resulting therefore in an average for this organization of $200/ID card); for each participating sponsor, number of registered users in each community organization or school that have made a purchase in the recent past (e.g., by month, over the last 6 months), comparing that to the total number of registered users in each community organization or school.

In the digital exchange system 100, sponsors 106 may enter the conditions for sponsorship or to enhance sponsorship, such as purchases made on a specific day or time of day. The sponsor 106 may also enter temporary programs or promotions during which time the sponsorship levels increase. The digital exchange system 100 may also be programmed to automatically send electronic notifications to selected participants 112 and community organizations 102.

Referring again to FIG. 2, it can be seen that an embodiment of the invention includes operating the digital exchange system 100 in connection with a point-of-sale (POS) system 150. In particular embodiments, the process is initiated when, for example, a community resident, in this case acting as a participant 112, enters, for example, a retail establishment of a sponsor 106 having a POS system 150 that is capable of linking participant sales to the digital exchange server 140. One way this may be accomplished is by assigning a particular function key or keys that make the association, such that a cashier may press the function key at the beginning, during or at the end of a transaction to indicate that the transaction is to be associated with the digital exchange system 100 (see FIG. 1). In this way, the digital exchange system 100 may be credited with a percentage of the proceeds from each of these sales or a fixed predetermined amount for each sale. Those credited proceeds are then allocated to the appropriate community organization 102 in accordance with the relevant sponsorship plan 110. For example, a participant 112 may be issued an identification (ID) card having the unique identification code 116 referred to above, thus indicating an affiliation with the digital exchange.

In this manner, the POS system 150 can assign and track all sales resulting from those particular sponsorships being initiated by the digital exchange, and provide in a single document, a spreadsheet in a predetermined format for example, the total sales volume for a given period that is associated with the digital exchange. This data may be provided to the operator of the digital exchange system 100 to facilitate the transfer of any funds due the digital exchange. In a particular embodiment, this data is transferred electronically between the POS system 150 of the sponsor 106 and the digital exchange system 100. Such data transfers may occur automatically at predetermined intervals (e.g., weekly or the first day of the month). In alternate embodiments, the data may be transferred electronically between the POS system 150 and the digital exchange system 100 by system operators or automatically.

To effect the subsequent transfer of funds from the digital exchange system 100 to its various community organizations 102, in at least one embodiment of the invention, the participant 112 accesses the digital exchange system 100, via the network using a PC or via a mobile application for example, to enter relevant data concerning any transactions that should be credited to a particular community organization 102. In certain embodiments of the invention, when the participant 112 accesses the digital exchange system 100, the participant 112 is given the option of allowing any proceeds from the participant's recent transaction(s) to flow to one or more previously selected community organizations 102. This may be a default allocation for any proceeds generated for the digital exchange system 100 by the participant 112. In a particular embodiment, this default allocation to one or more community organizations 102 is stored in the digital exchange system 100 until modified or deleted by the participant 112. The participant 112 also has the option to designate one or more other community organizations 102 to receive the proceeds from any transactions being entered into the digital exchange system 100. The proceeds can be divided among one or more community organizations 102 in any percentages specified by the participant 112.

The digital exchange system 100 can be further programmed to periodically (e.g., monthly, weekly, daily, etc.) generate reports regarding purchases made under each sponsorship plan 110 during the period, allocations to community organizations during the period, and invoices to sponsors 106 and/or community organizations for services provided by the digital exchange

However, in alternate embodiments of the invention, when sponsors 106 without a POS system 150, the cashier and/or participant may use a networked personal computer or a mobile device such as a tablet, or smart phone, or business kiosk with the appropriate application software platform to enter any data for transactions which may be requested by the digital exchange system 100. Furthermore, the sponsor 106 may have a mobile electronic communications device for the entry of information to be transmitted to the digital exchange system 100. In particular embodiments, the mobile electronic communications device may run a mobile application configured to transfer information to the digital exchange system 100 in a specific format or sequence.

For example, if the participant has an ID card and unique identification code 116 associated with the digital exchange system 100, the cashier may scan and/or enter all of the necessary data into the mobile communications device at the time of the sale. Alternatively, data may be entered by the participant, at a designated business kiosk, and may include an ID card with an identification code 116 or some other identifying information, along with the details of the particular transaction with the sponsor 106. In these cases, data can be entered into the kiosk or mobile application in an online or offline fashion. If in offline mode, the data can be transferred electronically subsequently to the digital exchange system 100.

The digital exchange system 100 may be configured to automatically reconcile the data from the participant with that provided from the POS system 150 of the sponsor 106. In certain embodiments, any inconsistencies in the data from the sponsor 106 and participant 112 are flagged by the digital exchange system 100 so that the appropriate corrections can be made.

In an alternate embodiment of the invention, the sponsor 106 may obtain certain information from the participant 112 at the time of sale to allow the digital exchange system 100 to make the allocations without additional input from the participant 112. For example, the cashier may request a phone number or ID card number from the participant 112, and the POS system will record both the digital exchange system 100 and the participant identification code 116 associated with the transaction. Without any additional input from the participant 112, the digital exchange system 100 can use this information provided by the POS system 150 to properly allocate funds to community organizations 102 (and from there to needs, programs and participants 112 within the community organization 102) based on the default selections made by the participant 112.

In this embodiment, the participant 112 may still have the option of accessing the digital exchange system 100 to modify the default allocations, or specify new allocations, for particular transactions. For example, the participant 112 may specify that all proceeds from transactions with one sponsor 106 go to a first community organization 102, while all proceeds from transactions with a second sponsor 106 go to a second community organization 102. Another example, the participant 112 may specify that proceeds from transactions go to multiple community organizations 102, with specified percentage weights.

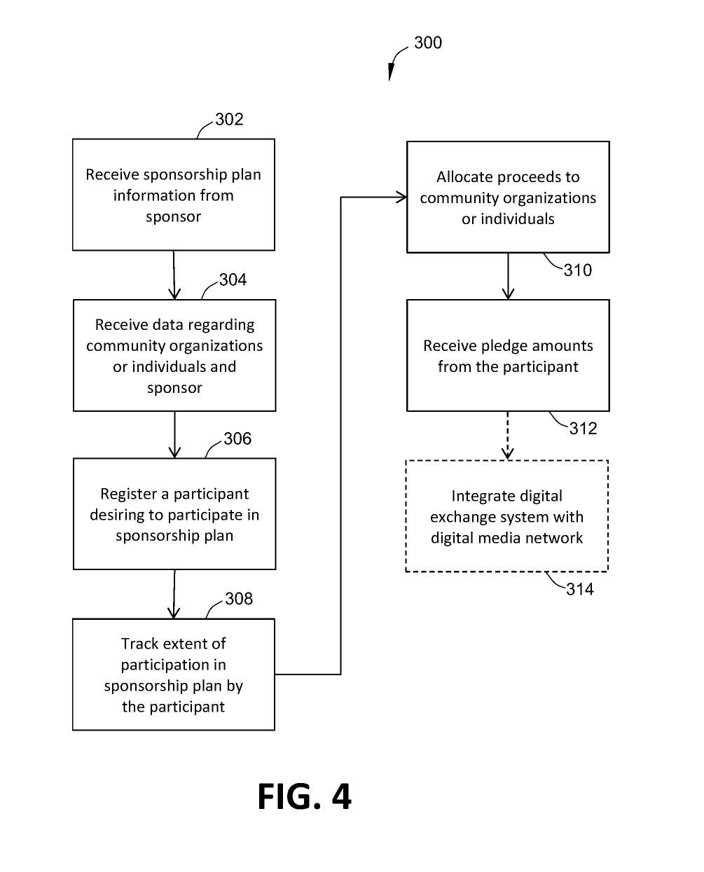

FIG. 4 is a flowchart illustrating an exemplary method of operating a digital exchange system 300. In an embodiment of the method shown in FIG. 4, the digital exchange system receives an electronic communication from the sponsor 302 with information regarding a sponsorship plan being offered by the sponsor. This information may include details on how participants can take advantage of the offer put forth by the sponsor, and how much the sponsor will contribute for purchases or other actions taken by the participant. The digital exchange also receives electronic communications from individuals, organizations, or sponsors 304 with specific profile information. This information may include personal information used to identify and communicate with the provider of the information. Information from the individual or organization may also include the amount of funding desired, the timing for obtaining the funding, the purpose for the funding, and how the funds will benefit the individual or organization and the community as a whole.

As explained above, in certain embodiments, participants in the digital exchange system will be asked to register and to provide information 306 which could be used to construct or complete a participant profile. Part of the registration process may involve issuance of a unique identification code for the participant. As also explained above, the digital exchange system tracks the level of participation in each sponsorship plan 308. This may include performing the calculations of monthly purchase amounts input through the system, breakdowns by business category, organization, sponsor, number of registered users, etc.

The method of FIG. 4 also requires the digital exchange system to automatically allocate the proceeds 310 from participation in the sponsorship plans to the appropriate individual or organization. The digital exchange also receives electronic communications from participants with projected pledge amounts 312. The projected pledge amounts may be based on a sampling of the sponsorship proposals available for the individual or community organization being supported by the participant.

Optionally, the method of the present invention may include integrating the digital exchange system with a digital media network 314 (shown in phantom) that contains digital media publications configured to provide electronic magazines, websites, and mobile applications. Participants are provided subscriptions to such digital media publications, or pre-subscriptions to potential digital media publications, where the subscriptions are linked to the digital exchange system. The method may also include requesting registration of individuals for participation in one or more sponsorship offer plans or for subscription to the digital media network. Alternatively, the method may include electronically sending information regarding sponsorship and media platform subscriptions, and summarizing results of the participants and comparing the results to those of an organization or subgroup and the goals of the organization and subgroup. Further still the method may include tracking activity in the digital exchange system, allocating media coverage points, earned each time a tracked activity is detected on the digital exchange system, and notifying the one or more organizations or individuals when a specified level of media coverage points are earned, making the one or more organizations or individuals aware that media coverage on the digital media network is available.

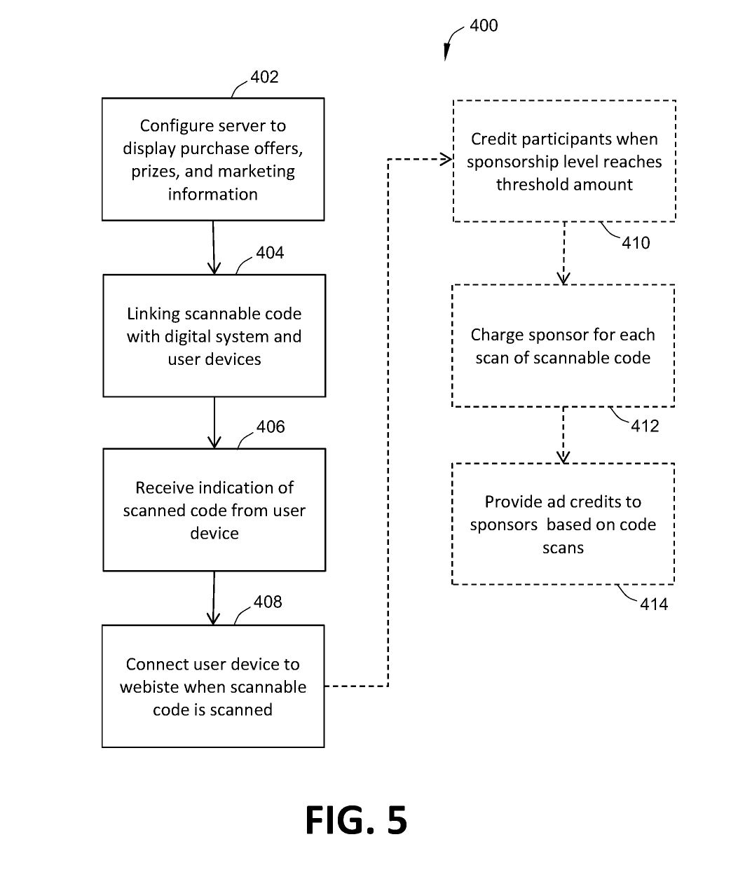

FIG. 5 is a flowchart illustrating an exemplary method of operating a digital system 400. In an embodiment of the method, shown in FIG. 5, calls for configuration of the digital exchange system server 402 to display purchase offers, prizes, and other marketing information. The method also requires linking a scannable code with the digital system and the electronic devices of system-users 404. These devices include, but are not limited to, smartphones, tablet computers, laptop computers, and notebook computers. The digital exchange system also receives an electronic communication 406 indicating when the scannable code has been scanned by the system user. Upon receiving this electronic communication, the digital exchange system connects the device which scanned the code to a website 408, which may contain a service directory. On this website, the system-user may be presented with a number of different offers from members listed in the service directory. The offers may include prizes, gift cards, discounted purchase deals, rebates of some kind, etc.

Optionally, the method of the present invention may include crediting a participant 410 (shown in phantom), with reward points for example, when the participant's sponsorship level reaches a threshold amount, or when the participant's scanning or sponsorship activities satisfy certain predetermined criteria. Another optional step of the method includes charging the sponsor a first fee 412 (shown in phantom) for each scan of the scannable code recorded by the digital exchange system when the scan does not result in a sale. A second fee, higher than the first fee, is charged to the sponsor when the scan does result in sale. However, when the number of scans recorded by the digital exchange system or the amount of fees charged to the sponsor reaches a threshold level, the sponsor may be provided with advertising credits 414 (shown in phantom), which the sponsor may use to place promotional advertisements in the various outlets of the digital media platform.

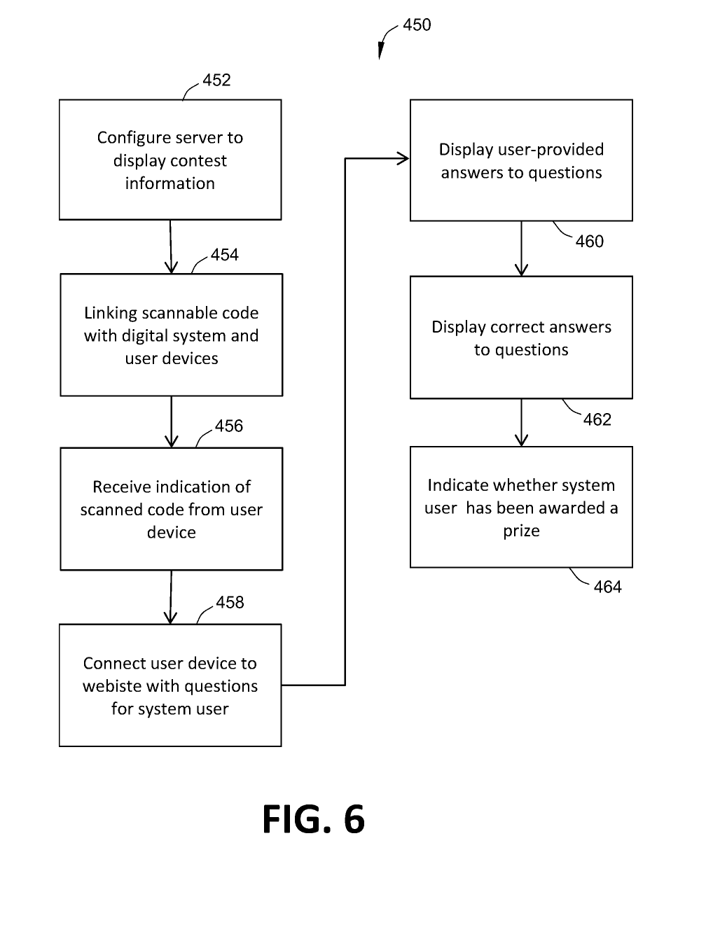

FIG. 6 is a flowchart illustrating an exemplary method of operating a digital system 450. The method includes the steps of providing a server connected to a communications network configured for two-way communications for system users. The method further includes configuring the server to display contest information 452, and linking scannable codes with the system and user devices 454. When one of the scannable codes is scanned, the server receives an indication 456 that the code has been scanned by a participant. The user device that scanned the scannable code is connected to a website 458 where information is presented and questions pertaining to that information displayed. The method further includes accepting and displaying, on a system-user device, user answers to the questions 460. The method also calls for subsequently displaying correct answers and comparing the correct answers with the user answers 462. Further still, the method includes indicating whether the user has received a prize or been entered into a drawing for a prize 464.

It is envisioned that, in some instances, sponsors will pay a specified amount for each scan of a scannable code, such as a QR code or bar code. While the examples provided below typically refer to QR codes, it is understood that the present invention is not limited to QR codes, but may include scannable codes of different types, such as barcode and 3-D barcode. Businesses, or sponsors, may pay a specified first amount for a scan that does not result in a purchase, and may pay a specified second amount, (typically higher than the first amount) for a scan that does result in a purchase. These scan amounts will be tracked and once the amount reaches a predetermined level of amount, an advertising space is allotted to that business on a determined media platform. For example, the QR code or bar codes may be placed in a daily print newspaper. Once the scan charges reach a certain level, the business will be notified that a certain amount of advertising inventory is available for that business to run/display an ad at no additional or lower charges.

In an embodiment of the invention, the digital exchange system 100 is configured to offer a sponsorship system for tuition assistance or contributions to college savings plans whereby the user participates in an educational question/answer process and a winner is selected from those that answer the set of one or more questions correctly. The user scans/reads a scannable code (for example, a QR code or bar code being scanned by an app on a smart phone or computer tablet), via an electronic device capable of scanning the code, such as mobile electronic device (e.g., smartphone, tablet computer, etc.). The code can be displayed on any media platform, digital or otherwise, for example, within a newspaper, magazine, website, digital magazine, email, poster bulletin, window cling, newsletter, etc. After the code is scanned, the user's mobile device 144 is connected to a website where information is provided, for example, via a set of slides, or through a video, or through photos with captions, or through articles. This code can be a companion to other media content, like as a companion to an article in a newspaper, where the information in the code educational system is relevant to the article in the newspaper. The user is identified by the system via the unique user registration information, such as user ID, password, cell phone number, exchange/network ID number, etc. After the information is presented, the user answers a set of one or more questions. Depending on the answers, the user may be positioned for a drawing for a “prize”—such as an amount of money towards a college savings plan or tuition reimbursement.

In a particular embodiment of the invention, the QR code or bar code targets specific individuals who participate in a sponsorship and/or digital network where purchase offers, prizes, and/or other marketing information are presented through a code that can be scanned/read, for example via a mobile device app (like a QR code or bar code being scanned by an app on a smart phone or computer tablet). After scanning, the QR code or bar code, the user device 144 (e.g., smartphone, laptop computer, notebook computer, tablet computer, etc.) is connected to a website where a business deal is presented to the user that is unique to that user.

The uniqueness of the deal is determined by an algorithm or set of algorithms within the digital exchange system 100, based on the activity of the user in the digital exchange system 100, and/or information input by the user into the digital exchange system 100. The user is identified by the digital exchange system 100 via the unique user registration information, such as user ID, password, cell phone number, exchange/network ID number, etc. The deal can be for a purchase that includes a discount, a purchase that includes a sponsorship for one or more schools, organizations or programs within (at different levels—see claim 4), a gift card or prize, a purchase that includes a raffle ticket for determined prizes, or a combination thereof. The scannable code can be displayed on any media platform, digital or otherwise, for example, within a newspaper, magazine, website, digital magazine, email, poster bulletin, newsletter, etc. In particular embodiments, Reward Points may be earned as the user uses the digital exchange system 100—in other words, a certain amount of points is earned for scanned offers that are declined, scanned offers that are accepted (meaning purchases are made), purchase activity in the digital network, etc.

In a particular embodiment of the invention, the QR code or bar code system is used by a user, for example a business, to target specific customer sets based on organization/school memberships or participation, or based on sponsor exchange purchase activity. For example, businesses may target network users that are currently not their customers (where the definition of current customer is provided by the business—e.g., a cardholder/participant may be a current customer of a business if he/she has made a purchase in the last three months). Or businesses may target customers that will agree to make purchases at non-peak hours or seasons. Or alternatively, businesses may target participants of certain organizations, schools, or programs.

In a certain embodiment, a QR code or bar code is placed in/on a media platform (e.g., a newspaper, magazine, digital magazine, website, etc.). The QR code or bar code is scanned with a digital app that sends the user to a digital application platform where the user can then log in and begin the process of proposing a sponsorship event. The digital exchange system 100 may be configured such that the extent of exchange activity provides reward points for media coverage for schools, organizations, and programs. Therefore, the digital exchange system 100 tracks the activity in the digital media network 104 and “media coverage points” are earned each time activity such as purchases are made or QR code or bar codes are scanned. Once a specified level of media coverage points are earned, an automatic notification is sent, electronically, to the relevant school, organization, team or program and the appropriate media coverage is established and executed. In some cases, “points” are earned for media coverage—where a certain amount of points will earn coverage of an event of the organization, school, or program within. Media coverage includes situations where some effort is made to cover an event and publish an article or video or photos of the event.

Embodiments of the invention include methods where a QR code or bar code system on a given media platform (e.g., a newspaper, magazine, digital magazine, website, etc.) serves as a service directory that is attached to the digital media network 104 for a given region, that displays purchase deals for services/products that offer sponsorships for community organizations, schools and programs. The deals may include discounts, gift cards, reward points, or raffle tickets for an upcoming raffle event.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of operating a digital exchange system, the method comprising:
providing a server connected to a communications network configured for two-way communications with system users;
configuring the server to display, on a system-user device, information on one or more community organizations or individuals and sponsorship needs thereof;
accepting, and displaying on the system-user device, electronically-submitted sponsorship offer plans from a sponsor for one of the one or more community organizations or individuals;
accepting data regarding the one or more community organizations or individuals and the sponsor, the data submitted electronically by system users associated with the sponsor or the one or more community organizations or individuals;
registering a participant desiring to participate in one or more sponsorship offer plans, wherein said participation establishes an electronic link in the digital exchange system between the participant and the one or more community organizations or individuals;
tracking an extent of participation in the sponsorship offer plan by the participant;
allocating proceeds to the one or more community organizations or individuals based on the extent of participation in the sponsorship offer plan by the participant; and
configuring the server to accept data regarding pledge amounts of purchase or pledge amounts of sponsorship from the participant.

2. The method of claim 1, further comprising:
facilitating purchase selections by the participant from a list of consumer items, the selections made via a user interface; and
calculating sponsorship amounts based on the participant selections.

3. The method of claim 1, further comprising providing possible purchase opportunities to make purchases from sponsors so that the participant can attain the pledged amount of sponsorship.

4. The method of claim 1, further comprising notifying the participants about opportunities to purchase with specific sponsorship offers from sponsors.

5. The method of claim 1, further comprising:
integrating the digital exchange system with a digital media network that contains digital media publications, configured to provide electronic magazines, websites, and mobile applications, whereby participants are provided subscriptions or subscribe to such digital media publications, or pre-subscribe to potential digital media publications, where the subscriptions are linked to the digital exchange system; and
requesting registration of individuals for participation in one or more sponsorship offer plans or for subscription to the digital media network.

6. The method of claim 1, further comprising:
integrating the digital exchange system with a digital media network that contains digital media publications, configured to provide electronic magazines, websites, and mobile applications, whereby participants are provided subscriptions or subscribe to such digital media publications, or pre-subscribe to potential digital media publications, where the subscriptions are linked to the digital exchange system;
electronically sending information regarding sponsorship and media platform subscriptions; and
tabulating and displaying results of the participants and comparing the results to those of an organization or subgroup and the goals of the organization and subgroup.

7. The method of claim 1, further comprising:
integrating the digital exchange system with a digital media network that contains digital media publications, configured to provide electronic magazines, websites, and mobile applications, whereby participants are provided subscriptions or subscribe to such digital media publications, or pre-subscribe to potential digital media publications, where the subscriptions are linked to the digital exchange system;
tracking activity in the digital exchange system;
allocating media coverage points, earned each time a tracked activity is detected on the digital exchange system; and
notifying the one or more organizations or individuals when a specified level of media coverage points are earned, making the one or more organizations or individuals aware that media coverage on the digital media network is available.

8. The method of claim 1, further comprising electronically sending a request to an individual to participate in a specific sponsorship initiative, event or sponsorship offer plan.

9. The method of claim 1, further comprising:
automatically sending an electronic communication with information regarding the acceptance of a sponsorship proposal by one of the one or more individuals or community organizations or a subgroup within that community organization, or by the sponsor; and
electronically sending a petition from the participant to other participants and individuals to participate in the accepted sponsorship proposal, wherein the digital system provides an ID for those that accept the request and are not currently linked to the relevant organization, school or subgroup.

10. The method of claim 1, further comprising:
electronically receiving a sponsorship proposal from a participant for a sponsorship event or sponsorship offer plan, wherein the sponsorship proposal is created by the participant from a template stored on the digital exchange system;
electronically sending the proposal from the participant to a potential sponsor.

11. The method of claim 10, further comprising;
electronically receiving a response from the potential sponsor accepting or declining the offer, or receiving an alternate sponsorship proposal from the potential sponsor;
automatically sending notifications to participants, linked by the communications network, once the response is received.

12. The method of claim 11, further comprising placing a scannable code on a media platform, wherein one of the system users scans the scannable code and the respective system-user device is connected to a website, web address, or URL within the system to propose a sponsorship event or sponsorship offer plan.

13. The method of claim 1, electronically sending a request from the participant for a pledge arrangement to be used to attain a sponsorship goal or for one or more sponsorship offer plans.

14. A method of operating a digital system, the method comprising:
providing a server connected to a communications network configured for two-way communications for system users;
configuring the server to display purchase offers, prizes, or other marketing information on system-user devices;
accepting electronically-submitted purchase offers from entities;
identifying the user via unique user registration information;
linking scannable codes with the digital system and user devices, so that when one of the scannable codes is scanned, the system-user device, on which the scan was made, is connected to a website, web address, or URL within the system where an offer from one of a number of entities, selected by the system, is presented, wherein the offer can be a discount associated with a purchase, a sponsorship amount associated with a purchase, a gift card, a rebate, or a prize.

15. The method of claim 14, wherein the offer is unique to the user, and wherein the uniqueness of the offer is determined by an algorithm or set of algorithms within the digital system, and is based on activity of the user within the digital system or information input by the user into the digital system.

16. The method of claim 14, where redeemable reward points are earned and tabulated in the system when the user scans one of the scannable codes.

17. The method of claim 16, wherein the tabulated amount of scanning activity or earned reward points affect the offers presented.

18. The method of claim 14, wherein accepted and unaccepted offers are tracked by the digital system, and wherein an entity providing the offer is charged a first amount for each scan that does not result in a sale, and is charged a second amount, higher than the first amount, for each scan that does result in a sale.

19. The method of claim 18, further comprising automatically tracking code scan costs.

20. The method of claim 19, wherein advertising credits are earned by an entity providing offers and paying for scans of the scannable codes, and wherein the advertising credits can be applied to an advertisement or promotion in a media outlet.

21. The method of claim 14, further comprising providing the offers to target specific customer sets identifiable by data collected by and stored in the system.

22. The method of claim 21, wherein the customer set includes network users that are not currently customers of the entity, where the customer set is defined by the entity providing the offer.

23. The method of claim 21, wherein the customer set includes network users that agree to make purchases during non-peak hours, or on non-peak days, or during non-peak seasons of the year.

24. The method of claim 21, wherein the customer set includes network users that belong to specific community organizations, or schools, or groups, or teams.

25. The method of claim 14, further comprising:
linking scannable codes to a system that serves as an entry point to a service directory;
when the scannable code is scanned by a system user, sending the user device of the system user to a website, web address, or URL that contains a service directory;
displaying offers, for system users, from entities in the service directory.

26. The method of claim 25, wherein the offers include prizes or gift cards.

27. The method of claim 25, wherein a referral network is included, wherein system users, linked by the communications network, provide referrals to each other.

28. The method of claim 27, wherein gift cards or reward points are earned by system users providing referrals.

29. The method of claim 14, wherein reward points are earned and tracked each time a system user scans a scannable code and is connected to a website, web address, or URL in the system to view an offer, wherein the reward points can be redeemed to reduce a subscription price for a media platform.

30. The method of claim 14, further comprising:
configuring the server to display, on a system-user device, information on one or more community organizations or individuals and sponsorship needs thereof;
accepting, and displaying on the system-user device, electronically-submitted sponsorship offer plans from a sponsor for one of the one or more community organizations or individuals;
accepting data regarding the one or more community organizations or individuals and the sponsor, the data submitted electronically by system users associated with the sponsor or the one or more community organizations or individuals;
registering a participant desiring to participate in one or more sponsorship offer plans, wherein said participation establishes an electronic link in the digital exchange system between the participant and the one or more community organizations or individuals;
tracking an extent of participation in the sponsorship offer plan by the participant; and
allocating proceeds to the one or more community organizations or individuals based on the extent of participation in the sponsorship offer plan by the participant.

31. A method of operating a digital system, the method comprising:
providing a server connected to a communications network configured for two-way communications for system users;
configuring the server to display, on a system-user device, contest information;
linking scannable codes with the digital system and system-user devices, so that when one of the scannable codes is scanned, the system-user device is connected to a website, web address or URL where information is presented and questions pertaining to that information displayed;
accepting and displaying, on a system-user device, user answers to the questions;
subsequently displaying correct answers and comparing the correct answers with the user answers; and
indicating whether the user has been awarded a prize or been entered into a drawing for a prize.
